(19) United States
(12) Patent Application Publication
(10) Pub. No.: US 2021/0277230 A1
(43) Pub. Date: Sep. 9, 2021

(54) POLYMER BLENDS CONTAINING THERMOPLASTIC AND CROSS-LINKED REACTION PRODUCT FROM POLYADDITION OR POLYCONDENSATION

(71) Applicant: Covestro Intellectual Property GmbH & Co. KG, Leverkusen (DE)

(72) Inventors: Andreas Seidel, Dormagen (DE); Mandy Gieler, Dernau (DE)

(21) Appl. No.: 17/261,288

(22) PCT Filed: Jul. 22, 2019
(86) PCT No.: PCT/EP2019/069656

§ 371 Date: Jan. 19, 2021

(30) Foreign Application Priority Data
Jul. 25, 2018 (EP) 18185513.1

(51) Int. Cl. C08L 69/00

(52) U.S. Cl. CPC C08L 69/00; C08L 2310/00; C08L 2205/03

(57) ABSTRACT

The invention relates to a polymer blend of at least one thermoplastic component and a further crosslinked, polymeric component, in which this further component is formed in situ in an extruder or kneader during the melt compounding of the thermoplastic component(s) by polyaddition or polycondensation reaction of starting components containing functional groups. The invention also relates to a process for producing the polymer blend, to the use of the polymer blend for the production of shaped bodies and to the shaped bodies themselves.

The present invention relates to a polymer blend, to the use of the polymer blend for the production of shaped bodies and to the shaped bodies themselves. The invention also relates to a process for producing the polymer blend.

Polymers have been known for a long time and are used for a large number of applications. However, the development of new polymers is generally laborious, expensive and time-consuming, and the scale up to production scale often requires high investments.

As far as is technically possible, the property profiles of polymeric plastics are therefore preferably adapted to new market requirements via the production of polymer mixtures and the preparation of corresponding formulations. This involves mixing various thermoplastics and possibly further additives in the melt in suitable units such as kneaders and extruders. This process step is also referred to as compounding. The mixtures obtained are called polymer blends. Compared to the development of new polymers, this procedure has the advantage of shorter development times and lower investment intensity, since customary mixing units are in principle generally suitable for the production of a very wide variety of polymer mixtures and thus frequently only minor modifications, if any at all, for example to the metering systems, to the mixing elements or to the screw configurations, have to be made in order to be able to provide new products and launch them successfully on the market.

In most cases, in the industrial-scale production of polymer blends the polymeric species are mixed with each other in the melt. Although it is possible in this case for the polymers to react with one another here via functional groups, the actual chain buildup reactions have been at least largely completed prior to the production of the polymer blend by compounding.

Through the selection and the quantitative ratios of the constituents of the composition of polymer blends, the performance properties, such as mechanical properties, rheology and thermal resistance, of the molding compounds produced therefrom by compounding and the shaped bodies produced from such compositions or molding compounds can be varied within wide ranges.

However, in most cases a certain miscibility or at least partial compatibility of the blending partners is necessary for the achievement of advantageous property profiles, since otherwise undesired phase separation and phase delamination occur. In addition, in most cases the polymers to be mixed have to be able to be melted under the thermal conditions of the compounding when exposed to reasonably achievable mechanical energy, without thermally decomposing in the process, and have to be able to be uniformly and preferably finely interdispersed under such conditions in order to be able to realize the desired advantageous properties. As a result, the production of polymer blends in most cases is restricted to the blending of thermoplastic polymers.

Even in the event of good compatibility of the blending partners, there is generally no mixing at the molecular level. Instead, the individual blending partners in most cases form a multiphasic morphology with more or less finely dispersed domains spatially separated by interfaces. Therefore, even in the case of mixtures of two transparent polymers, opaque blends often result since the light is scatted in all directions at the phase interfaces of such multiphasic polymer blends. The realization of transparent polymer blends having, compared to the pure polymers from which they have been produced, improved mechanical and/or optical properties or other advantageous properties is therefore generally only possible to a very limited degree using conventional compounding methods.

The phase interfaces in multiphasic polymer blends can in addition also become weak points upon mechanical loading. Material failure, in particular also under the influence of aggressive media, thus occurs more frequently along these interfaces.

Thermoset or elastomeric polymers, that is to say highly crosslinked polymers, which decompose at higher temperatures before they become thermoplastic, have to date been suitable for the production of polymer blends only in specific cases. In these cases, it is necessary to give the thermosets or elastomers the desired microparticulate structure as early as during the production of these polymers or at least prior to the production of the polymer blend by compounding. This can be done, for example, by grinding or emulsion or suspension polymerization. Furthermore, when producing polymer blends containing such thermosets or elastomers it is often necessary or at the least advantageous to ensure compatibility with respect to the matrix polymer by way of an appropriate particle shell, which should preferably be chemically bonded (grafted on) to the thermoset or elastomer. Such thermosets or elastomers having a core-shell structure are obtainable for example via emulsion or suspension polymerization and are used for example as impact modifiers. Polymer blends in which the thermoset or elastomer constitute the matrix phase are in principle not obtainable in this way, which severely limits the range of achievable property profiles. The production of polymers and polymer blends in a reactive extrusion process in which the monomeric constituents or oligomeric precursors of the polymer or of a polymeric blending partner are polymerized in an extruder, generally in the presence of a catalyst, and in the case of polymer blends in the presence of the previously polymerized further blending partners, has likewise been described in the prior art.

For example, WO 200837772 discloses a process for preparing a polylactide-urethane copolymer in which a polylactide having terminal hydroxyl groups is prepared by contacting at least one lactide monomer with a diol or a diamine in the presence of a catalyst and polymerizing the terminally hydroxyl group-functionalized polylactide thus prepared with a diisocyanate compound, likewise in the presence of a catalyst, characterized in that both the polylactide and the polylactide-urethane copolymer are prepared by means of reactive extrusion.

The approach, within the context of a reactive extrusion process, of a chain buildup reaction during the compounding of polymers which have already been formed beforehand in conventional ways is also described in JP 6034202 B2 and in K. Matsumoto et al., J. Appl. Polym. Sci. (2013) 443-448. There, a resin composition containing polycarbonate and polyolefin is mixed with allylically polyfunctionalized monomers and a peroxide as a free-radical chain polymerization initiator in a compounding unit. In this case, the allylically polyfunctionalized monomers in a first step are absorbed into polycarbonate powder and then in a second process step during the compounding of the polycarbonate monomer mixture thus produced are polymerized to completion with polypropylene in the polycarbonate melt to afford a crosslinked polymer. The polymer blends thus obtained feature a finely divided and processing-stable phase morphology.

An example of the production of a polymer blend containing a thermoplastic polymer and a crosslinked elastomer in a reactive extrusion process is disclosed in DE 10 2010 052 973 A1. In this document, a thermoplastic elastomer having increased temperature resistance is prepared by, in a first process step, heating and as a result melting cyclobutylene terephthalate (CBT) in an extruder or an internal mixer and mixing a pulverulent elastomer which has already been completely vulcanized into the CBT and, in a second process step, polymerizing the mixture thus obtained, with addition of a catalyst, in situ to afford polybutylene terephthalate.

EP 0334186 A2 discloses improved thermoplastic polymer mixtures containing A) 70-95 parts by weight of a thermoplastic polyurethane obtainable by reaction of a) a diisocyanate, b) a short-chain chain extender and c) a hydroxyl group-containing higher molecular weight compound, and B) 30 to 5 parts by weight of a thermoplastic polyester. It is disclosed that the thermoplastic polyester can also be metered in during the polyurethane formation in a twin-screw kneading machine. With regard to this production method, reference is also made to DE 2302564. The thermoplastic polymer mixtures of EP 0334186 A2 feature an improved tear propagation resistance and increased hardness, and can be readily processed.

DE 4217509 A1 discloses epoxy resin mixtures for fiber composite materials containing a polyfunctional epoxy compound, a hardener, a soluble thermoplastic or rubber and finely divided silicon dioxide. The epoxy resin mixture features a viscosity which is well suited to the fiber impregnation.

It is known from DE 199 01 419 A1 to produce thermoplastically processable blends from a thermoplastic polymer and a thermoset polymer by mixing the thermoplastic component with an uncured thermosetting component in a compounding process, characterized in that the thermosetting component is cured during the production of the polymer blend by addition of a crosslinker.

However, the production of thermoplastically processable polymer blends having a high proportion of thermoset polymer is often not possible using the processes described in the prior art. In particular, the production of thermoplastically processable polymer blends having co-continuous phase structure with highly branched polymers as blending partners is not possible in such processes. Likewise, it is also not possible in such a process to produce thermoplastically processable polymer blends having thermoset polymer as matrix component.

It is thus often not possible, or not possible to the extent desired, to combine the positive properties of thermoplastics (for example, good processability and recyclability) and thermosets or elastomers (for example, resistance to chemicals, mechanical properties and surface hardness) in an advantageous or even synergistic manner.

In addition, by means of compounding it is often—even using the methods of reactive extrusion described—not possible, or not possible to the extent desired, to achieve an optimal distribution of a plurality of polymers among one another, in particular such a homogeneous distribution of a plurality of polymers without disruptive phase interfaces, that is to say high transparency.

It was therefore desirable to provide a polymer blend which does not exhibit at least one of the disadvantages mentioned here, or exhibits it to a reduced extent, and which can be produced in an—optionally multistage—compounding process using customary compounding units.

It was in particular desirable to provide a thermoplastically processable polymer blend having improved mechanical properties. In this case, in particular an improved toughness, preferably even at low temperatures, an improved material resilience (e.g. tensile stress at yield) and/or an improved surface hardness (scratch resistance) were desirable.

It was furthermore desirable to provide a polymer blend having an improved balance between resistance to the influence of chemicals and melt flowability (thermoplastic processability in injection molding processes).

It was furthermore desirable to provide a polymer blend having increased transmission, preferably a transparent polymer blend having the advantageous properties described hereinabove.

In particular, it was desirable to provide a polymer blend which features improved mechanical properties and/or improved balance between resistance to the influence of chemicals and melt flowability and which can be thermoplastically processed at elevated temperatures to give shaped bodies without decomposition of one or more of the blend components occurring to an appreciable extent, that is to say in a way which influences the desired properties of the blend to a degree which is unacceptable in the light of the respective development target.

Another object was that of providing polymer blends and a process for producing same, where the polymer blends contain two thermoplastic, immiscible polymers and nevertheless have a finely dispersed and processing-stable phase morphology.

Surprisingly, it has been found that a polymer blend containing
A) a thermoplastic polymer selected from the group consisting of polycarbonates, polyester carbonates, polyesters and polyamides, or a monophasic mixture of a plurality of thermoplastic polymers selected from the group consisting of polycarbonates, polyester carbonates, polyesters and polyamides,
B) optionally at least one further thermoplastic polymer which is different from component A and is not completely miscible with component A,
C) 1 to 200 parts by weight, based on 100 parts by weight of component A, of a cross-linked or branched polymer,
   characterized
   in that component C is formed in situ in an extruder or kneader during the melt compounding of component A and optional further components in the presence of
      C.1 a first monomeric or oligomeric component containing functional groups C.1.1 and
      C.2 a second monomeric or oligomeric component containing functional groups C.2.1 which are different from C.1.1,
   by polyaddition or polycondensation in a reaction of the functional groups C.1.1 of component C.1 with the functional groups C.2.1 of component C.2,
   where components C.1 and C.2 are
   difunctional or higher-functionality compounds or are mixtures of one or more difunctional and/or one or more higher-functionality compounds,
   and where at least one of the components C.1 and C.2 contains higher-functionality compounds,
      has the desired profile of properties.

The polymer blend may furthermore contain unreacted residual amounts of component C.1 and/or C.2.

The polymer blend may furthermore contain, as component D, up to 50 parts by weight, based on a total of 100 parts by weight of components A, B and C, of polymer additives and/or processing auxiliaries.

In a preferred embodiment, the proportion of component C, based on 100 parts by weight of component A, is 5 to 100 parts by weight, particularly preferably 10 to 50 parts by weight.

In a preferred embodiment, the proportion of component D, based on a total of 100 parts by weight of components A, B and C, is 0.001 to 20 parts by weight, more preferably 0.01 to 10 parts by weight, particularly preferably 0.1 to 7 parts by weight.

In a specific embodiment, the polymer blend furthermore contains, as component B, a second thermoplastic polymer or a monophasic mixture of a plurality of thermoplastic polymers which are not completely miscible with component A. In preferred polymer blends, components A and B form separate phases.

The proportion of component A is 1 to 99 parts by weight, based on a total of 100 parts by weight of components A and B, the proportion of component B is 99 to 1 parts by weight, based on a total of 100 parts by weight of components A and B, and the proportion of component C is 1 to 200 parts by weight, based on 100 parts by weight of component A. The proportion of component D is up to 50 parts by weight, based on a total of 100 parts by weight of components A, B and C.

In this specific embodiment, the proportion of component A, based on a total of 100 parts by weight of components A and B, is preferably 60 to 97 parts by weight, more preferably 70 to 95 parts by weight, particularly preferably 75 to 90 parts by weight.

As an alternative, in this specific embodiment the proportion of component A, based on a total of 100 parts by weight of components A and B, is preferably 3 to 40 parts by weight, more preferably 5 to 30 parts by weight, particularly preferably 10 to 25 parts by weight.

Also, in this specific embodiment, the proportion of component C, based on 100 parts by weight of component A, is preferably 5 to 100 parts by weight, particularly preferably 10 to 50 parts by weight.

Furthermore also, in this specific embodiment, the proportion of component D, based on a total of 100 parts by weight of components A, B and C, is preferably 0.001 to 20 parts by weight, more preferably 0.01 to 10 parts by weight, particularly preferably 0.1 to 7 parts by weight.

The preferred ranges mentioned hereinabove with respect to the proportions by weight of components A, C and D can in this case be combined with one another in any manner in all embodiments, the proportion by weight of component B in the specific embodiment being calculated via normalization from the proportion by weight of component A via the equation

proportion by weight of B=100 parts by weight−proportion by weight of A.

The polymer blends preferably consist to an extent of 90% by weight, more preferably to an extent of 95% by weight and particularly preferably to an extent of 100% by weight of components A, B, C and D and unreacted residual amounts of components C.1 and/or C.2.

A further embodiment of the present invention is a process for producing the polymer blends.

In this process, components A, C.1 and C.2 and optionally B and D are mixed and, in a mixing and compounding unit, preferably selected from the group consisting of internal kneaders, extruders and twin-screw extruders, are melt compounded and melt extruded. The temperature conditions are guided by the component A chosen and, if present, by component B as well. The temperature must be selected so that components A and B melt and no decomposition occurs.

Within the context of this application, this process is referred to in general as melt compounding or simply as compounding.

The melt compounding preferably takes place at temperatures of 150° C. to 350° C., more preferably at 180° C. to 320° C., very particularly preferably at 220° C. to 300° C.

If the reaction of components C.1 and C.2 is a polycondensation reaction, during the melt compounding volatile reaction products which form during the polymerization of components C.1 with C.2 to afford the polymer of component C are continuously withdrawn from the compounding unit in order to shift the polymerization equilibrium by applying a negative pressure, preferably of at most 100 mbar absolute, more preferably of at most 10 mbar absolute, particularly preferably of at most 1 mbar absolute, to the mixing and compounding unit.

The individual constituents of the polymer blends can be mixed in known fashion, either successively or simultaneously, either at about 20° C. (room temperature) or at a higher temperature. This means, for example, that some of the constituents can be metered in via the main intake of an extruder and the remaining constituents can be fed in later in the compounding process via a side extruder.

In a particular embodiment, in a first process step (i) first the components A and C.1 and/or A and C.2 are physically premixed, before in a second process step (ii) the remaining components are added and the mixture is melt compounded.

In a further particular embodiment, in a first process step (i) first the components C.1 and C.2 individually or separately are physically premixed with component A (i.e. it is possible to produce a mixture of C.1 with A and a further mixture of C.2 with A, or a mixture of C.1 and C.2 with A, preference being given to producing a mixture of C.1 with A and a further mixture of C.2 with A) and optionally further components, before, in the second process step (ii) of melt compounding, the remaining components containing a catalyst for the reaction of C.1 with C.2 are added. In the process according to this embodiment, in process step (ii) the thermoplastic polymer of component C is formed by polycondensation or polyaddition and the final blend morphology is formed.

The first process step is preferably implemented by melt compounding. In special cases where component C.1 and/or C.2 cannot be melted without decomposition or sublimate, or where the melting temperature is higher than the thermal resilience of component A or B, it may be expedient or necessary to employ an alternative physical mixing method in process step (i). For example, in such cases it is possible to dissolve C.1 and/or C.2 and A in a common solvent, with subsequent removal of the solvent (e.g. by spray drying) and/or precipitation using a complementary solvent.

### Component A

The component A used is at least one polymer selected from the group consisting of polycarbonates, polyester carbonates, polyesters and polyamides, or a monophasic mixture of a plurality of thermoplastic polymers selected from the group consisting of polycarbonates, polyester carbonates, polyesters and polyamides.

Preference is given to using a polymer selected from the group consisting of polycarbonates, polyester carbonates and polyesters, particular preference being given to using at least one polymer selected from the group consisting of aromatic polycarbonates and aromatic polyester carbonates, and very particular preference being given to using one or more aromatic polycarbonates.

The polymers of component A are preferably linear.

Aromatic polycarbonates and/or aromatic polyester carbonates in accordance with component A which are suitable in accordance with the invention are known from the literature or preparable by processes known from the literature (for preparation of aromatic polycarbonates see, for example, Schnell, “Chemistry and Physics of Polycarbonates”, Interscience Publishers, 1964, and also DE-AS 1 495 626, DE-A 2 232 877, DE-A 2 703 376, DE-A 2 714 544, DE-A 3 000 610, DE-A 3 832 396; for preparation of aromatic polyester carbonates, for example DE-A 3 077 934).

Aromatic polycarbonates are prepared, for example, by reacting diphenols with carbonic halides, preferably phosgene, and/or with aromatic dicarbonyl dihalides, preferably benzenedicarbonyl dihalides, by the interfacial process, optionally using chain terminators, for example monophenols, and optionally using trifunctional or more than trifunctional branching agents, for example triphenols or tetraphenols. Preparation via a melt polymerization process by reaction of diphenols with for example diphenyl carbonate is likewise possible.

Diphenols for the preparation of the aromatic polycarbonates and/or aromatic polyester carbonates are preferably those of formula (I)

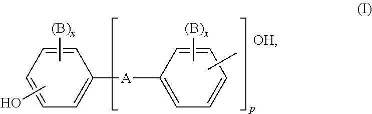

where
A is a single bond, C1 to C5-alkylene, C2 to C5-alkylidene, C5 to C6-cycloalkylidene, —O—, —SO—, —CO—, —S—, —SO2-, C6 to C12-arylene, onto which may be fused further aromatic rings optionally containing heteroatoms,
or a radical of formula (II) or (III)

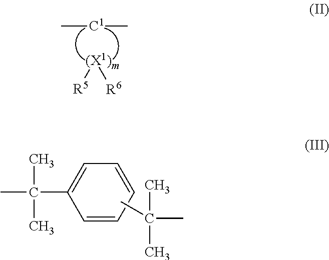

B in each case is C1 to C12-alkyl, preferably methyl, halogen, preferably chlorine and/or bromine,
x is independently at each occurrence 0, 1 or 2,
p is 1 or 0, and
R5 and R6 can be chosen individually for each X1 and are each independently hydrogen or C1 to C6-alkyl, preferably hydrogen, methyl or ethyl,
X1 is carbon and
m is an integer from 4 to 7, preferably 4 or 5, with the proviso that R5 and R6 on at least one X1 atom are simultaneously alkyl.

Preferred diphenols are hydroquinone, resorcinol, dihydroxydiphenols, bis(hydroxyphenyl)-C1-C5-alkanes, bis(hydroxyphenyl)-C5-C6-cycloalkanes, bis(hydroxyphenyl) ethers, bis(hydroxyphenyl) sulfoxides, bis(hydroxyphenyl) ketones, bis(hydroxyphenyl) sulfones and a, α-bis(hydroxyphenyl)diisopropylbenzenes, and the ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulfide, 4,4′-dihydroxybiphenyl sulfone, and also the di- and tetrabrominated or chlorinated derivatives of these, such as for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is especially preferred.

The diphenols may be used individually or in the form of any desired mixtures. The diphenols are known from the literature or obtainable by processes known from the literature.

Examples of chain terminators suitable for the preparation of the thermoplastic aromatic polycarbonates include phenol, p-chlorophenol, p-tert-butylphenol or 2,4,6-tribromophenol, but also long-chain alkylphenols such as 4-[2-(2,4,4-trimethylpentyl)]phenol, 4-(1,1,3,3-tetramethylbutyl)phenol according to DE-A 2 842 005 or monoalkylphenols or dialkylphenols having a total of 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The thermoplastic, aromatic polycarbonates preferably have mean weight-average molecular weights (Mw, measured by gel permeation chromatography in methylene chloride at 25° C. with polycarbonate based on bisphenol A as standard) of from 10 000 to 50 000 g/mol, preferably 15 000 to 40 000 g/mol, particularly preferably 20 000 to 35 000 g/mol.

Both homopolycarbonates and copolycarbonates are suitable. For the preparation of copolycarbonates of component A according to the invention, it is also possible to use 1% to 25% by weight, preferably 2.5% to 25% by weight, based on the total amount of diphenols to be used, of polydiorganosiloxanes having hydroxyaryloxy end groups. These are known (U.S. Pat. No. 3,419,634) and can be prepared by processes known from the literature. The preparation of polydiorganosiloxane-containing copolycarbonates is described in DE-A 3 334 782.

Preferred polycarbonates are not only the bisphenol A homopolycarbonates but also the copolycarbonates of bisphenol A comprising up to 15 mol %, based on the molar sums of diphenols, of other diphenols mentioned as preferred or particularly preferred, in particular 2,2-bis(3,5-dibromo-4-hydroxyphenyl)propane.

In a preferred embodiment suitable polyesters are aromatic, more preferably are polyalkylene terephthalates.

In a particularly preferred embodiment they are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component, of terephthalic acid radicals and at least 80% by weight, preferably at least 90% by weight, based on the diol component, of ethylene glycol and/or butane-1,4-diol radicals.

In addition to terephthalic acid radicals, the preferred aromatic polyalkylene terephthalates may contain up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred aromatic polyalkylene terephthalates may contain not only ethylene glycol and/or butane-1,4-diol radicals but also up to 20 mol %, preferably up to 10 mol %, of other aliphatic diols having 3 to 12 carbon atoms or cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane (DE-A 2 407 674, 2 407 776, 2 715 932).

Particular preference is given to aromatic polyalkylene terephthalates which have been prepared solely from terephthalic acid and the reactive derivatives thereof (e.g. the dialkyl esters thereof) and ethylene glycol and/or butane-1,4-diol, and to mixtures of these polyalkylene terephthalates.

Preferred mixtures of aromatic polyalkylene terephthalates contain 1% to 50% by weight, preferably 1% to 30% by weight, of polyethylene terephthalate and 50% to 99% by weight, preferably 70% to 99% by weight, of polybutylene terephthalate.

The aromatic polyalkylene terephthalates preferably used have a viscosity number of 0.4 to 1.5 dl/g, preferably 0.5 to 1.2 dl/g, measured in phenol/o-dichlorobenzene (1:1 parts by weight) at a concentration of 0.05 g/ml according to ISO 307 at 25° C. in an Ubbelohde viscometer.

The aromatic polyalkylene terephthalates can be prepared by known methods (see, for example, Kunststoff-Handbuch, volume VIII, p. 695 et seq., Carl-Hanser-Verlag, Munich 1973).

Aromatic dicarbonyl dihalides for the preparation of aromatic polyester carbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio between 1:20 and 20:1.

In the preparation of polyester carbonates, a carbonic halide, preferably phosgene, is also additionally used as a bifunctional acid derivative.

Useful chain terminators for the preparation of the aromatic polyester carbonates include, apart from the monophenols already mentioned, the chlorocarbonic esters thereof and the acid chlorides of aromatic monocarboxylic acids, which may optionally be substituted by C1 to C22-alkyl groups or by halogen atoms, and aliphatic C2 to C22-monocarbonyl chlorides.

The quantity of chain terminators in each case is from 0.1 to 10 mol %, based on moles of diphenol in the case of the phenolic chain terminators and on moles of dicarbonyl dichloride in the case of monocarbonyl chloride chain terminators.

The aromatic polyester carbonates may also incorporate aromatic hydroxycarboxylic acids.

The proportion of carbonate structural units in the thermoplastic aromatic polyester carbonates may be varied as desired. The proportion of carbonate groups is preferably up to 100 mol %, in particular up to 80 mol %, particularly preferably up to 50 mol %, based on the sum of ester groups and carbonate groups. Both the ester fraction and the carbonate fraction of the aromatic polyester carbonates may be present in the form of blocks or in random distribution in the polycondensate.

The thermoplastic aromatic polycarbonates and polyester carbonates may be used alone or in any desired mixture.

In an embodiment of the present invention, the thermoplastic polymer of component A used is amorphous and/or semicrystalline polyamides. Suitable polyamides are aliphatic polyamides, for example PA-6, PA-11, PA-12, PA-4,6, PA-4,8, PA-4,10, PA-4,12, PA-6,6, PA-6,9, PA-6,10, PA-6,12, PA-10,10, PA-12,12, PA-6/6,6 copolyamide, PA-6/12 copolyamide, PA-6/11 copolyamide, PA-6,6/11 copolyamide, PA-6,6/12 copolyamide, PA-6/6,10 copolyamide, PA-6,6/6,10 copolyamide, PA-4,6/6 copolyamide, PA-6/6,6/6,10 terpolyamide, and copolyamide formed from cyclohexane-1,4-dicarboxylic acid and 2,2,4- and 2,4,4-trimethylhexamethylenediamine, aromatic polyamides, for example PA-6,1, PA-6,1/6,6 copolyamide, PA-6,T, PA-6,T/6 copolyamide, PA-6,T/6,6 copolyamide, PA-6,1/6,T copolyamide, PA-6,6/6,T/6,1 copolyamide, PA6,T/2-MPMDT copolyamide (2-MPMDT=2-methylpentamethylenediamine), PA-9,T, copolyamide formed from terephthalic acid, 2,2,4- and 2,4,4-trimethylhexamethylenediamine, copolyamide formed from isophthalic acid, laurolactam and 3,5-dimethyl-4,4-diaminodicyclohexylmethane, copolyamide formed from isophthalic acid, azelaic acid and/or sebacic acid and 4,4-diaminodicyclohexylmethane, copolyamide formed from caprolactam, isophthalic acid and/or terephthalic acid and 4,4-diaminodicyclohexylmethane, copolyamide formed from caprolactam, isophthalic acid and/or terephthalic acid and isophoronediamine, copolyamide formed from isophthalic acid and/or terephthalic acid and/or further aromatic or aliphatic dicarboxylic acids, optionally alkyl-substituted hexamethylenediamine and alkyl-substituted 4,4-diaminodicyclohexylamine or copolyamides thereof, and mixtures of the aforementioned polyamides.

In a further embodiment of the present invention, the component A used is semicrystalline polyamides which have advantageous thermal properties. In this context, semicrystalline polyamides having a melting point of at least 200° C., preferably of at least 220° C., more preferably of at least 240° C. and more preferably still of at least 260° C., are used. The higher the melting point of the semicrystalline polyamides, the more advantageous the thermal behavior of the compositions according to the invention. The melting point is determined by DSC.

Preferred semicrystalline polyamides are selected from the group comprising PA-6, PA-6,6, PA6,10, PA-4,6, PA-11, PA-12, PA-12,12, PA-6,1, PA-6,T, PA-6,T/6,6 copolyamide, PA-6,T/6 copolyamide, PA-6/6,6 copolyamide, PA-6,6/6,T/6,1 copolyamide, PA-6,T/2-MPMDT copolyamide, PA-9,T, PA-4,6/6 copolyamide and the mixtures or copolyamides thereof.

Further-preferred semicrystalline polyamides are PA-6,1, PA-6,T, PA-6,6, PA-6,6/6T, PA6,6/6,T/6,1 copolyamide, PA-6,T/2-MPMDT copolyamide, PA-9,T, PA-4,6 and the mixtures or copolyamides thereof.

### Component B

As component B, in principle all types of thermoplastic polymers or monophasic mixtures of two or more than two such thermoplastic polymers are suitable, under the condition that component A and component B are not completely miscible in the polymer blend. This means that components A and B in the polymer blends according to the invention preferably form separate phases.

Component B preferably does not contain any functional groups according to C.1.1 or C.2.1.

In a preferred embodiment, component B has a lower melt viscosity than component A under the pressure, temperature and shear rate conditions in the production of the polymer blend by melt compounding.

Component B is preferably a polyolefin, a vinyl (co)polymer, a mixture of various polyolefins or vinyl (co)polymers or a mixture of one or more polyolefins with one or more vinyl (co)polymers.

More preferably, component B is a polyolefin, a monophasic mixture of a plurality of polyolefins or a mixture of a plurality of polymers containing at least one polyolefin.

Polyolefins are prepared by chain polymerization, preferably by free-radical polymerization. Monomers used are alkenes. An alternative name for alkenes is olefins. The monomers may be polymerized individually or as a mixture of various monomers.

Preferred monomers are ethylene, propylene, 1-butene, isobutene, 1-pentene, 1-heptene, 1-octene and 4-methyl-1-pentene.

The polyolefins may contain up to 50% by weight, more preferably up to 30% by weight, of vinylic comonomers, for example methyl acrylate, ethyl acrylate, butyl acrylate and methyl methacrylate.

The polyolefins are usually semicrystalline and may be linear or branched. The preparation of polyolefins has long been known to those skilled in the art.

The polymerization may be conducted for example at pressures of from 1 to 3000 bar and temperatures between 20° C. and 300° C., optionally with use of a catalyst system. Examples of suitable catalysts include mixtures of titanium and aluminum compounds, and metallocenes.

By modifying the polymerization conditions and the catalyst system, the number of branches, the crystallinity and the density of the polyolefins can be varied within wide ranges. These measures are also familiar to those skilled in the art.

The vinyl (co)polymers are (co)polymers of at least one monomer from the group of vinylaromatics, vinyl cyanides (unsaturated nitriles) and (C1 to C8)-alkyl (meth)acrylates.

Especially suitable vinyl (co)polymers are (co)polymers of

B.1 50% to 99% by weight, preferably 65% to 85% by weight, particularly preferably 70% to 80% by weight, based on the (co)polymer B, of at least one monomer selected from the group of the vinylaromatics (for example styrene, α-methylstyrene), ring-substituted vinylaromatics (for example p-methylstyrene, p-chlorostyrene) and (C1-C8)-alkyl (meth)acrylates (for example methyl methacrylate, n-butyl acrylate, tert-butyl acrylate) and
B.2 1% to 50% by weight, preferably 15% to 35% by weight, particularly preferably 20% to 30% by weight, based on the (co)polymer B, of at least one monomer selected from the group of vinyl cyanides (for example unsaturated nitriles such as acrylonitrile and methacrylonitrile), (C1-C8)-alkyl (meth)acrylates (for example methyl methacrylate, n-butyl acrylate, tert.-butyl acrylate).

These (co)polymers B are resinous, thermoplastic and rubber-free.

Such vinyl (co)polymers B are known and can be prepared by free-radical polymerization, in particular by emulsion, suspension, solution or bulk polymerization. The (co)polymers B have a weight-average molecular weight (Mw), determined by gel permeation chromatography (GPC) in tetrahydrofuran with polystyrene as standard, of preferably from 50 000 to 200 000 g/mol, particularly preferably from 70 000 to 150 000 g/mol, particularly preferably from 80 000 to 130 000 g/mol.

### Component C

Component C is a branched or crosslinked polymer containing structural units derived from
C.1 a first monomeric or oligomeric component containing functional groups C.1.1 and
C.2 a second monomeric or oligomeric component containing functional groups C.2.1 which are different from C.1.1.

Within the context of the present patent application, functional groups are groups of atoms containing heteroatoms which significantly determine the reaction behavior of the components bearing them.

Examples of components C.1 or C.2 containing functional groups are epoxides, amines, alcohols, thiols, anhydrides, isocyanates, nitriles, carboxylic acids, sulfonic acids, aldehydes, ketones and ethers.

As component C.1, mixtures of substances may also be used, the substances possibly differing in terms of molecular weight and/or their chemical structure. These differences relate for example to alkyl chains of different lengths, to branches in the alkyl chains or to either aliphatic or aromatic carbon skeletons. However, in these mixtures the constituents still in each case have the same functional groups.

Equally, component C.2 may also consist of a mixture of substances which, while they have the same functional groups, differ in terms of their molecular weight and/or their chemical structure.

The functional groups are selected such that a reaction of the groups C.1.1 with the groups C.1.2 can take place.

Preferably, the functional groups C.1.1 and C.2.1 are selected from the group of reaction pairings consisting of epoxy groups and carboxyl groups, epoxy and hydroxyl groups, hydroxyl and carboxyl groups, isocyanate and hydroxyl groups, amino and carboxyl groups, amino and epoxy groups, amino and isocyanate groups, and anhydride and amino groups.

The reaction can be accelerated by a thermal activation or by addition of a catalyst.

Components C.1 and C.2 are difunctional or higher-functionality compounds or are mixtures of one or more structurally dissimilar difunctional and/or one or more structurally dissimilar higher-functionality compounds, at least one of the components C.1 and C.2 containing higher-functionality compounds. Higher-functionality compounds are those compounds having more than two functional groups per molecule. The higher-functionality compounds preferably contain 3 or 4 functional groups per molecule.

Component C.1 and/or component C.2 preferably contains at least 5 mol % of higher-functionality compounds, preferably 10 to 40 mol %, in each case based on component C.1 and/or C.2.

The higher-functionality compounds of component C.1 are for example trifunctional epoxides and the higher-functionality compounds of component C.2 are for example trifunctional carboxylic acids.

Component C is formed by polyaddition or polycondensation in a reaction of the functional groups C.1.1 of component C.1 with the functional groups C.2.1 of component C.2.

Preferred components C.1 are epoxides or isocyanates.

Preferred components C.2 are alcohols, carboxylic acids or amines and mixtures thereof.

The reaction between C.1 and C.2, that is to say between the functional groups C.1.1 and C.2.1, takes place in situ in an extruder or kneader during the melt compounding in the presence of component A, optionally in the presence of components B and D. The conditions customary for the melt compounding of component A in terms of temperature, pressure and residence time in the extruder or kneader are maintained during the process.

Preferably, in total at least 40% by weight, more preferably at least 50% by weight, particularly preferably at least 80% by weight, most preferably at least 90% by weight, of the components of C.1 and C.2 used are converted to afford the polymer of component C during the melt compounding.

Component C.1 and component C.2 are preferably homogeneously miscible with the melt of component A in the quantitative ratios used under the conditions of the melt compounding of component A and optional further components.

Due to the at least partial polyfunctionality of component C.1 and/or C.2, mentioned above, the component C formed has a branched or crosslinked structure.

Component C is preferably selected from the group consisting of crosslinked epoxy resins, crosslinked polyurethanes, crosslinked polyureas, crosslinked polyesters and crosslinked polyamides. Component C is more preferably selected from the group consisting of crosslinked epoxy resins, crosslinked polyurethanes and crosslinked polyureas. Component C is particularly preferably a crosslinked epoxy resin.

For the preparation of the epoxy resins as component C, in a preferred embodiment the component C.1 used is a representative or a mixture of a plurality of representatives selected from preferably aromatic di- or multi-glycidyl ethers. Preference is given to the diglycidyl ethers of diphenols. Examples of suitable and preferably suitable diphenols for the preparation of such diglycidyl ethers include the same diphenols of formula (I) as are also used or preferably used in the preparation of the polycarbonates of component A. Particular preference is given to using bisphenol A. These diphenols may be used individually or as any desired mixtures in the preparation of oligomeric or prepolymeric diglycidyl ethers.

As component C.1, those higher-functionality, optionally oligomeric or prepolymeric glycidyl ethers having three, four or more than four epoxy groups containing structural units derived from phenolic compounds having three or four phenolic OH groups are suitable. These are prepared proceeding from phenolic compounds having three or four phenolic OH groups. In the preparation of higher-functionality oligomeric or prepolymeric glycidyl ethers, these phenolic compounds having three or four phenolic OH groups may also be used in any desired mixture with diphenols in the preparation of component C.1. Preferably, however, in the preparation of such higher-functionality oligomeric or prepolymeric glycidyl ethers the content of diphenols, based on the sum of all phenolic structural units, is at least 50 mol %, more preferably at least 80 mol %, particularly preferably at least 90 mol %. Most preferably, 100 mol % diphenols, that is to say no phenolic compounds having three and four phenolic groups, is used in the preparation of component C.1.

The diphenol diglycidyl ethers are prepared by reaction of the diphenol or of the diphenol mixture with epichlorohydrin in the presence of sodium hydroxide. In a two-stage reaction, in this case first epichlorohydrin is added onto the diphenol, and subsequently with a stoichiometric amount of sodium hydroxide solution the bis-epoxide is formed therefrom which can then—when using a molar excess of diphenol—react with further diphenol molecules to form an oligomer or prepolymer. Depending on the ratio of diphenol and epichlorohydrin used, oligomers or prepolymers having two terminal glycidyl ether groups are formed in this way, the molecular weight of the oligomer or prepolymer thus obtained depending on the ratio of diphenol and epichlorohydrin used. The higher-functionality glycidyl ethers containing structural units derived from phenolic compounds having three or four phenolic OH groups and the oligomeric or prepolymeric higher-functionality glycidyl ethers containing both structural units derived from diphenols and structural units derived from phenolic compounds having three and/or four phenolic OH groups are also prepared analogously. As component C.1, both monomeric, oligomeric and polymeric glycidyl ethers and mixtures thereof are suitable.

As component C.1, bisphenol A diglycidyl ether (often also referred to as BADGE) or the oligomeric products Epon™ 2002-2005 from Hexion Inc. (Columbus, USA) are suitable with preference and by way of example.

As component C.1 or as a constituent of component C.1, tris(4-hydroxyphenyl)methane triglycidyl ether, the di-, tri- and/or tetraglycidyl ether of 1,1′,2,2′-tetrakis(p-hydroxyphenyl)ethane, poly- or oligo[(o-cresyl glycidyl ether)-co-formaldehyde], tris(2,3-epoxypropyl) isocyanurate, glycerol triglycidyl ether and diglycidyl terephthalate are furthermore suitable.

In an alternative preferred embodiment, the component C.1 used is a multiply glycidyl methacrylate-modified polymer or oligomer preferably containing aromatic structural units, particularly preferably a vinyl copolymer or oligomer.

For the preparation of the epoxy resins as component C, in a preferred embodiment the component C.2 used is a representative or a mixture of a plurality of representatives selected from compounds having two, three, four and more than four phenolic OH groups and/or (preferably or) carboxyl groups, particularly preferably a representative or a mixture of a plurality of representatives selected from phenolic compounds having two, three, four and more than four phenolic OH groups and aromatic carboxylic acids having two, three, four and more than four COOH groups. Furthermore, component C.2 used may be or more a dicarboxylic anhydrides.

More preferably, as component C.2, compounds having two, three, four or more than four phenolic OH groups or a mixture of a plurality of such phenolic compounds are used. Examples of such polyfunctional phenols which are suitable or preferably suitable include the diphenols of formula (I) as are used or preferably used also in the preparation of the polycarbonates of component A. Such polyfunctional phenols which are particularly preferably suitable are compounds having three, four or more than four phenolic groups. In a further preferred embodiment, component C.2 contains such polyfunctional phenols having three, four or more than four phenolic OH groups at a concentration, based on component C.2, of at least 5 mol %, more preferably at least 10 mol %, particularly preferably at least 25 mol %, very particularly preferably at least 50 mol %.

Examples of suitable polyfunctional phenols having three or four phenolic groups particularly preferably include phloroglucinol, 1,3,5-tris(4-hydroxyphenyl)benzene, 1,1,1-tris(4-hydroxyphenyl)ethane, 1,1′,2,2′-tetrakis(p-hydroxyphenyl)ethane and 2,2′,4,4′-tetrahydroxybenzophenone, particularly preferably 1,1,1-tris(4-hydroxyphenyl)ethane.

As compounds having more than four phenolic groups, examples of suitable components C.2 preferably include novolaks, polyvinylphenol and vinyl copolymers containing one or more structurally dissimilar vinyl-functionalized phenols, for example selected from the group comprising p- or o-vinylphenol, p- or o-allylphenol and 2-methoxy-4-vinylphenol.

Preferred examples of aromatic carboxylic acids having two, three or four carboxyl groups and suitable as component C.2 are phthalic acid, terephthalic acid, isophthalic acid, 1,3,5-benzenetricarboxylic acid, 1,2,4-benzenetricarboxylic acid, 1,3,5-tris(4-carboxyphenyl)benzene, 1,2,4,5-tetrakis(4-carboxyphenyl)benzene and mixtures of a plurality of these carboxylpolyfunctionalized compounds. It may preferably also be used as a mixture comprising polyfunctional phenols having two, three, four and/or more than four phenolic OH groups as component C.2. In a further preferred embodiment, component C.2 contains aromatic carboxylic acids having three and/or four carboxyl groups and phenolic compounds having three, four and/or more than four phenolic groups at a concentration, based on component C.2, of at least 5 mol %, more preferably at least 10 mol %, particularly preferably at least 25 mol %, very particularly preferably at least 50 mol % of all constituents of component C.2.

In a particular embodiment, component C forms a polymeric network which, in a temperature range below the decomposition temperatures of components A and C and also of optional component B, exchanges covalent bonds intramolecularly and/or intermolecularly in a dynamic manner. As a result, the polymer blend becomes thermoplastically formable even at a high degree of crosslinking and/or with a high content of component C. The covalent bond exchange can be accelerated by suitable catalysts.

### Component D

The composition may optionally further contain, as component D, polymer additives and/or processing auxiliaries.

Useful components D include, for example, flame retardants (for example phosphorus or halogen compounds), flame retardant synergists (for example nanoscale metal oxides), smokeinhibiting additives (for example boric acid or borates), antidripping agents (for example compounds from the substance classes of the fluorinated polyolefins, the silicones and aramid fibers), internal and external lubricants and demolding agents (for example pentaerythrityl tetrastearate, montan wax or polyethylene wax), flowability aids (for example low molecular weight vinyl (co)polymers), antistats (for example block copolymers of ethylene oxide and propylene oxide, other polyethers or polyhydroxy ethers, polyetheramides, polyesteramides or sulfonic salts), conductivity additives (for example conductive carbon black or carbon nanotubes), stabilizers (for example UV/light stabilizers, thermal stabilizers, antioxidants, transesterification inhibitors, hydrolysis stabilizers), antibacterial additives (for example silver or silver salts), scratch resistance-improving additives (for example silicone oils or hard fillers such as (hollow) ceramic beads or quartz powder), IR absorbents, optical brighteners, fluorescent additives, fillers and reinforcers (e.g. talc, ground glass fibers or carbon fibers, (hollow) glass or ceramic beads, mica, kaolin, CaCO3 and glass flakes), acids, catalysts (for example selected from the group consisting of tin compounds, zinc compounds, zirconium compounds, samarium compounds, phosphonium salts and ammonium salts) and dyes and pigments (for example carbon black, titanium dioxide or iron oxide), or else mixtures of a plurality of the additives mentioned.

In a preferred embodiment, as component or constituent of component D, a catalyst for the polycondensation or polyaddition reaction of components C.1 and C.2 to form component C is used. In a further preferred embodiment, the catalyst is selected from the group consisting of tin compounds, zinc compounds, zirconium compounds, samarium compounds, phosphonium salts and ammonium salts. Such catalysts used are particularly preferably representatives selected from the group consisting of tin compounds, zinc compounds, zirconium compounds and phosphonium salts.

In a preferred embodiment, as component D or constituent of component D, a catalyst for the acceleration of the intramolecular and/or intermolecular dynamic bond exchange of polymer C is furthermore used. In a preferred embodiment, catalysts suitable for this purpose are likewise selected from the group consisting of tin compounds, zinc compounds, zirconium compounds, samarium compounds, phosphonium salts and ammonium salts. Such catalysts used are particularly preferably likewise representatives selected from the group consisting of tin compounds, zinc compounds, zirconium compounds and phosphonium salts.

In a specific embodiment, the catalyst for the polycondensation or polyaddition reaction of components C.1 and C.2 to form component C and the catalyst for the acceleration of the intramolecular and/or intermolecular dynamic bond exchange of polymer C can be identical.

In a preferred embodiment, the compositions according to the invention each comprise, as component D, at least one component selected from the group of demolding agents and stabilizers.

In a particularly preferred embodiment, the demolding agent used is pentaerythrityl tetrastearate.

In a particularly preferred embodiment, the stabilizer used is at least one compound selected from the group of sterically hindered phenols, organic phosphites, sulfur-based co-stabilizers and Brønstedt-acidic compounds.

In a particularly preferred embodiment, the composition comprises, as stabilizer, at least one representative selected from the group consisting of octadecyl-3-(3,5-di-tert-butyl-4-hydroxyphenyl)propionate and tris(2,4-di-tert-butylphenyl)phosphite.

As component D, the compositions according to the invention can in a preferred embodiment also contain flame retardants, for example halogenated organic compounds or phosphoruscontaining flame retardants. The latter are used with preference.

### Production of the Shaped Bodies

The polymer blends according to the invention can be used to produce shaped bodies of any kind. These may be produced for example by injection molding, extrusion, hot pressing and blow-molding processes. A further form of processing is the production of shaped bodies by thermoforming from previously produced sheets or films.

Examples of such shaped bodies which can be produced from the polymer blends according to the invention are films, profiles, housing parts of any kind, for example for domestic appliances such as juice presses, coffee machines, mixers; for office machines such as monitors, flatscreens, notebooks, printers, copiers; sheets, pipes, electrical installation ducts, windows, doors and other profiles for the construction sector (interior fittings and external applications) and also electrical and electronic components such as switches, plugs and sockets, and parts for commercial vehicles, in particular for the automotive sector. The polymer blends according to the invention are also suitable for the production of the following shaped bodies or moldings: interior fitting components for rail vehicles, ships, aircraft, buses and other motor vehicles, bodywork parts for motor vehicles, housings for electrical appliances containing small-scale transformers, housings for information processing and transmission devices, housings and lining for medical appliances, massage appliances and housings therefor, children's toy vehicles, flat wall elements, housings for safety devices, thermally insulated transport containers, moldings for sanitary and bathroom equipment, cover grilles for blower vents and housings for garden appliances.

Embodiments 1 to 56 of the present invention are presented hereinafter.

1. A polymer blend containing
A) a thermoplastic polymer selected from the group consisting of polycarbonates, polyester carbonates, polyesters and polyamides, or a monophasic mixture of a plurality of thermoplastic polymers selected from the group consisting of polycarbonates, polyester carbonates, polyesters and polyamides,
B) optionally at least one further thermoplastic polymer which is different from component A and is not completely miscible with component A,
C) 1 to 200 parts by weight, based on 100 parts by weight of component A, of a crosslinked or branched polymer,
   characterized
   in that component C is formed in situ in an extruder or kneader during the melt compounding of component A and optional further components in the presence of
      C.1 a first monomeric or oligomeric component containing functional groups C.1.1 and
      C.2 a second monomeric or oligomeric component containing functional groups C.2.1 which are different from C.1.1,
   by polyaddition or polycondensation in a reaction of the functional groups C.1.1 of component C.1 with the functional groups C.2.1 of component C.2,
   where components C.1 and C.2 are
   difunctional or higher-functionality compounds or are mixtures of one or more difunctional and/or one or more higher-functionality compounds,
   and where at least one of the components C.1 and C.2 contains higher-functionality compounds.
      2. The polymer blend according to embodiment 1, characterized in that the functional groups C.1.1 and C.2.1 are selected from the group of reaction pairings consisting of epoxy groups and carboxyl groups, epoxy and hydroxyl groups, hydroxyl and carboxyl groups, isocyanate and hydroxyl groups, amino and carboxyl groups, amino and epoxy groups, amino and isocyanate groups, and anhydride and amino groups.
      3. The polymer blend according to embodiment 1 or 2, wherein component C.1 and component C.2 are homogeneously miscible with the melt of component A in the quantitative ratios used and under the conditions of the melt compounding of component A and optional further components.
      4. The polymer blend according to any of the preceding embodiments containing unreacted residual amounts of component C.1 and/or C.2.
      5. The polymer blend according to any of the preceding embodiments, containing
1 to 99 parts by weight of component A, based on a total of 100 parts by weight of components A and B,
99 to 1 parts by weight of component B, based on a total of 100 parts by weight of components A and B,
1 to 200 parts by weight, based on 100 parts by weight of component A, of a polymer of component C,
wherein component A and component B form separate phases in the polymer blend.
   6. The polymer blend according to any of the preceding embodiments, characterized in that component C forms a polymeric network which, in a temperature range below the decomposition temperatures of components A and C and also of optional component B, exchanges covalent bonds intramolecularly and/or intermolecularly in a dynamic manner.
   7. The polymer blend according to any of the preceding embodiments, containing 60 to 97 parts by weight of component A, based on a total of 100 parts by weight of components A and B.
   8. The polymer blend according to any of the preceding embodiments, containing 70 to 95 parts by weight of component A, based on a total of 100 parts by weight of components A and B.
   9. The polymer blend according to any of the preceding embodiments, containing 75 to 90 parts by weight of component A, based on a total of 100 parts by weight of components A and B.
   10. The polymer blend according to any of the preceding embodiments 1 to 6, containing 3 to 40 parts by weight of component A, based on a total of 100 parts by weight of components A and B.
   11. The polymer blend according to any of the preceding embodiments 1 to 6, containing 5 to 30 parts by weight of component A, based on a total of 100 parts by weight of components A and B.
   12. The polymer blend according to any of the preceding embodiments 1 to 6, containing 10 to 25 parts by weight of component A, based on a total of 100 parts by weight of components A and B.
   13. The polymer blend according to any of the preceding embodiments, containing 5 to 100 parts by weight of component C, based on 100 parts by weight of component A.
   14. The polymer blend according to any of the preceding embodiments, containing 10 to 50 parts by weight of component C, based on 100 parts by weight of component A.
   15. The polymer blend according to any of the preceding embodiments, characterized in that the component C.1 used is a representative or a mixture of a plurality of representatives selected from diglycidyl ethers, oligomeric glycidyl ethers and prepolymeric glycidyl ethers having two, three, four or more than four epoxy groups.
   16. The polymer blend according to embodiment 15, wherein the glycidyl ether are derived from diphenols and/or phenolic compounds having three and/or four phenolic OH groups.
   17. The polymer blend according to embodiment 16, wherein the glycidyl ethers are derived from diphenols to an extent of at least 80 mol %.
   18. The polymer blend according to embodiment 17, wherein the glycidyl ether is derived from bisphenol A.
   19. The polymer blend according to embodiment 15, wherein, as component C.1 or as a constituent of component C.1, at least one representative selected from the group consisting of tris(4-hydroxyphenyl)methane triglycidyl ether, the di-, tri- and/or tetraglycidyl ether of 1,1,2,2-tetrakis(p-hydroxyphenyl)ethane, poly- or oligo[(o-cresyl glycidyl ether)-co-formaldehyde], tris(2,3-epoxypropyl) isocyanurate, glycerol triglycidyl ether and diglycidyl terephthalate.
   20. The polymer blend according to any of the preceding embodiments, characterized in that component C.2 is a representative or a mixture of a plurality of representatives selected from compounds having two, three, four and more than four phenolic OH groups or carboxyl groups.
   21. The polymer blend according to embodiment 20, characterized in that component C.2 contains at least 10 mol % phenolic compounds having three, four or more than four phenolic OH groups.
   22. The polymer blend according to embodiment 20, characterized in that component C.2 contains at least 25 mol % phenolic compounds having three, four or more than four phenolic OH groups.
   23. The polymer blend according to any of embodiments 20 to 22, characterized in that component C.2 contains structural units derived from at least one representative from the group consisting of phloroglucinol, 1,3,5-tris(4-hydroxyphenyl)benzene, 1,1,1-tris(4-hydroxyphenyl)ethane, 1,1′,2,2′-tetrakis(p-hydroxyphenyl)ethane and 2,2′,4,4′-tetrahydroxybenzophenone, particularly preferably 1,1,1-tris(4-hydroxyphenyl)ethane.
   24. The polymer blend according to any of embodiments 1 to 20, characterized in that component C.2 contains at least one representative selected from the group consisting of phthalic acid, terephthalic acid, isophthalic acid, 1,3,5-benzenetricarboxylic acid, 1,2,4-benzenetricarboxylic acid, 1,3,5-tris(4-carboxyphenyl)benzene, 1,2,4,5-tetrakis(4-carboxyphenyl)benzene.
   25. The polymer blend according to any of the preceding embodiments, characterized in that in total at least 40% by weight of the components of C.1 and C.2 used are converted to afford the polymer of component C.
   26. The polymer blend according to any of the preceding embodiments, characterized in that in total at least 50% by weight of the components of C.1 and C.2 used are converted to afford the polymer of component C.
   27. The polymer blend according to any of the preceding embodiments, characterized in that in total at least 80% by weight of the components of C.1 and C.2 used are converted to afford the polymer of component C.
   28. The polymer blend according to any of the preceding embodiments, furthermore containing, as component D, up to 50 parts by weight, based on a total of 100 parts by weight of components A, B and C, of one or more polymer additives and/or processing auxiliaries.
   29. The polymer blend according to embodiment 28, containing 0.001 to 20 parts by weight, based on a total of 100 parts by weight of components A, B and C, of component D.
   30. The polymer blend according to embodiment 28, containing 0 01 to 10 parts by weight, based on a total of 100 parts by weight of components A, B and C, of component D.
   31. The polymer blend according to embodiment 28, containing 0.1 to 7 parts by weight, based on a total of 100 parts by weight of components A, B and C, of component D.
   32. The polymer blend according to any of embodiments 28 to 31, characterized in that component D contains at least one catalyst for the polycondensation or polyaddition reaction which leads to the formation of component C.
   33. The polymer blend according to embodiment 32, characterized in that the catalyst used is at least one representative selected from the group consisting of tin compounds, zinc compounds, zirconium compounds, samarium compounds, phosphonium salts and ammonium salts.
   34. The polymer blend according to any of embodiments 28 to 33, characterized in that component D furthermore contains a catalyst for the acceleration of the intramolecular and/or intermolecular dynamic bond exchange of polymer C according to embodiment 6.
   35. The polymer blend according to embodiment 34, wherein the catalyst is selected from the group consisting of tin compounds, zinc compounds, zirconium compounds, samarium compounds, phosphonium salts and ammonium salts.
   36. The polymer blend according to any of the preceding embodiments, characterized in that component B is a polyolefin, a vinyl (co)polymer, a mixture of various polyolefins or vinyl (co)polymers or a mixture of one or more polyolefins with one or more vinyl (co)polymers.
   37. The polymer blend according to any of the preceding embodiments, characterized in that component B does not contain any functional groups according to C.1.1 or C.2.1.
   38. The polymer blend according to any of the preceding embodiments, characterized in that component C is a thermoset polymer.
   39. The polymer blend according to any of the preceding embodiments, characterized in that component C is selected from the group consisting of crosslinked epoxy resins, crosslinked polyesters, crosslinked polyamides, crosslinked polyurethanes and crosslinked polyureas.
   40. The polymer blend according to embodiment 39, characterized in that component C is a crosslinked epoxy resin, a crosslinked polyurethane or a crosslinked polyurea.
   41. The polymer blend according to embodiment 40, characterized in that component C is a crosslinked epoxy resin.
   42. The polymer blends according to any of the preceding embodiments, consisting to an extent of 90% by weight of components A, B, C and D and unreacted residual amounts of components C.1 and/or C.2.
   43. The polymer blends according to any of the preceding embodiments, consisting to an extent of 95% by weight of components A, B, C and D and unreacted residual amounts of components C.1 and/or C.2.
   44. The polymer blends according to any of the preceding embodiments, consisting to an extent of 100% by weight of components A, B, C and D and unreacted residual amounts of components

C.1 and/or C.2.

45. A process for producing a polymer blend according to any of embodiments 1 to 44, characterized in that components A, C.1 and C.2 and optionally B and D are mixed and, in a mixing and compounding unit, preferably selected from the group consisting of internal kneaders, extraders and twin-screw extruders, are melt compounded and melt extruded.
46. Process according to embodiment 45, characterized in that
(i) in a first process step first at least one of the components C.1 and C.2 is physically premixed with component A and
(ii) in a second process step the premixture(s) produced in step (i) are melt compounded with addition of the remaining components and the polymer of component C is formed in the process by polyaddition or polycondensation and the final blend morphology is formed.
   47. Process according to embodiment 46, characterized in that
in process step (i) first the components C.1 and C.2 and optionally further components are physically premixed together or separately with component A and in process step (ii), as component D, a catalyst for the polyaddition or polycondensation reaction of C.1 with C.2 is additionally added.
   48. The process according to any of embodiments 45 to 47, characterized in that the melt compounding takes place in a temperature range from 150° C. to 350° C.
   49. The process according to any of embodiments 45 to 47, characterized in that the melt compounding takes place in a temperature range from 180° C. to 320° C.
   50. The process according to any of embodiments 45 to 47, characterized in that the melt compounding takes place in a temperature range from 220° C. to 300° C.
   51. The process according to any of embodiments 45 to 50, characterized in that the reaction between C.1 and C.2 to afford the polymer of component C is a polycondensation, and in that volatile reaction products which form during the polycondensation are continuously withdrawn from the compounding unit in order to shift the polymerization equilibrium by applying a negative pressure to the mixing and compounding unit.
   52. The process according to embodiment 51, characterized in that the negative pressure is at most 100 mbar absolute.
   53. The process according to embodiment 51, characterized in that the negative pressure is at most 10 mbar absolute.
   54. A polymer blend obtainable by a process according to any of embodiments 45 to 53.
   55. The use of a polymer blend according to any of embodiments 1 to 44 and 54 for the production of shaped bodies.
   56. A shaped body produced from a polymer blend according to any of embodiments 1 to 44 and 54.

### EXAMPLES

### Component A

Linear polycarbonate based on bisphenol A with a weight-average molecular weight M_{w} of 25 000 g/mol (determined by GPC at room temperature in methylene chloride as solvent against a BPA-PC standard).

### Component C.1

Epon™ 2002 (Hexion Inc., Columbus, Ohio, USA):

Epoxy resin of the formula

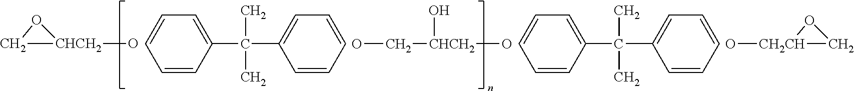

where n≈4, prepared from bisphenol A and epichlorohydrin. The epoxy content of component C.1, determined according to DIN 1877 (2000 version) is 5.9% by weight.

### Component C.2-1

Trimellitic acid (98%) (abcr GmbH, Karlsruhe, Germany)

The melting point of the trimellitic acid is about 230° C.

### Component C.2-2

Phthalic acid (>99.5%) (Sigma-Aldrich Chemie GmbH, Munich, Germany)

The melting point of the phthalic acid is about 190° C.

### Masterbatch 1

Masterbatch containing 80% by weight of component A and 20% by weight of component C.1.

Masterbatch 1 was produced by melt compounding using a ZSK25 twin-screw extruder from Coperion, Werner & Pfleiderer GmbH (Stuttgart, Germany) at a melt temperature of 270° C. No reduced pressure was applied during the production of masterbatch 1.

The epoxy content of the masterbatch 1 thus produced was determined according to DIN 1877 (2000 version) to be 1.1% by weight. This value corresponds, within the scope of the accuracy of determination, to the arithmetically expected value of 0.2·5.9% by weight=1.18% by weight, that is to say that there was no appreciable conversion of the epoxy functions during the production of masterbatch 1. The pellets of masterbatch 1 produced were completely transparent and colorless.

### Masterbatch 2

Masterbatch containing 99% by weight of component A, 0.2% by weight of component C.2.1 and 0.8% by weight of component C.2.2. Masterbatch 2 was produced by melt compounding using a ZSK25 twin-screw extruder from Coperion, Werner & Pfleiderer GmbH (Stuttgart, Germany) at a melt temperature of 240° C. No reduced pressure was applied during the production of masterbatch 2. The pellets of masterbatch 2 produced were completely transparent and colorless.

### Production of the Polymer Blends

### Example 1 According to the Invention

33% by weight of masterbatch 1 and 67.7% by weight of masterbatch 2 were melt compounded in a twin-screw laboratory extruder of the Process 11 type (Thermo Fisher Scientific GmbH, Karlsruhe, Germany) at a melt temperature of 260° C.

The ratio between masterbatches 1 and 2 was selected in the production of this polymer blend according to the invention so that the molar amount of epoxy functions introduced via masterbatch 1 arithmetically corresponds stoichiometrically to the molar amount of carboxyl functions introduced via masterbatch 2 in total by way of the phthalic acid and trimellitic acid.

The epoxy content of the compound thus produced was determined according to DIN 1877 (2000 version) to be 0.16% by weight. This value corresponds to a calculated conversion of epoxy functionalities introduced by component C.1 via masterbatch 1 of 56%. The pellets produced from the composition of example 1 were completely transparent and colorless.

### Comparative Example 2

### Component A

### Properties of the Polymer Blends

The shaped bodies for determining the performance properties were produced in an injection molding machine of the Arburg 270 E type (ARBURG Holding GmbH+Co. KG, LoBburg, Germany) at a melt temperature of 280° C. and at a mold temperature of 80° C.

The transparency was assessed visually on test specimens having dimensions of 80 mm×40 mm×4 mm.

The melt viscosity, as a measure of the melt flowability in the injection molding process, was determined according to ISO 11443 (2014 version) at a temperature of 300° C. and at a shear rate of 1000 s⁻¹ on molten pellets pre-dried at 120° C. for 16 h under reduced pressure.

The stress cracking resistance (environmental stress cracking=ESC) in rapeseed oil or in sun lotion of the Nivea™ Protect and Care Sun Lotion SPF30 type (Beiersdorf AG, Hamburg, Germany) serves as a measure for the resistance to chemicals. The time until stress cracking-induced fracture failure of an injection-molded test specimen having dimensions of 80 mm×40 mm×4 mm at room temperature was determined. For an assessment of the resistance to rapeseed oil, the test specimens were subjected to external edge fiber strain of 0.8% by means of a clamping template and completely immersed in the rapeseed oil. The measurement was performed according to DIN EN ISO 22088 (2006 version) and was stopped after 3 days (72 h) if no fracture failure resulted within this time (measurement value is in this case reported as >72 h). For an assessment of the resistance to sun lotion, the test specimens were subjected to external edge fiber strain of 2.4% by means of a clamping template and their surfaces covered with the sun lotion. The measurement was likewise performed according to DIN EN ISO 22088 (2006 version).

Tensile modulus and tensile stress at yield were determined on test specimens having dimensions of 170 mm×10 mm×3 mm according to ISO 527 (1996 version) at room temperature.

TABLE 1
measured properties

| Property | Example 1 | Comparative example 2 |
|---|---|---|
| Transparency | yes | yes |
| Melt viscosity [Pa s] | 91 | 219 |
| ESC (rapeseed oil) | >72 | >72 |
| Time until fracture at 0.8% | | |
| [h] | | |
| ESC (sun cream) | 1.3 | 1.3 |
| Time until fracture at 2.4% | | |
| [h] | | |
| Modulus of elasticity [MPa] | 2376 | 2149 |
| Tensile stress at yield | 70 | 60 |
| [N/mm²] | | |

The data in table 1 show that the polymer blend according to the invention of example 1, compared to the pure polycarbonate of comparable molecular weight of comparative example 2, for the same resistance to chemicals and optical quality (transparency), exhibits considerably improved melt flowability (reduced melt viscosity) and improved mechanical properties (increased modulus of elasticity as a measure of the material stiffness and tensile stress at yield as a measure of the maximum material resilience). Such polymer blends are therefore better suitable in particular for the production of thin-walled, delicate components which can only be produced with difficulty, if at all, using pure polycarbonate due to its inadequate melt flowability and stiffness or mechanical material resilience. In addition, the considerable improvement in melt flowability in such polymer blends makes it possible to use relatively high molecular weight polycarbonate, as a result of which materials can be produced having, compared to pure polycarbonate, improved resistance to chemicals with comparable or even, depending on the choice of the polycarbonate molecular weight, improved melt flowability.

1. A polymer blend comprising:
A) a thermoplastic polymer selected from the group consisting of polycarbonates, polyester carbonates, polyesters and polyam ides, or a monophasic mixture of a plurality of thermoplastic polymers selected from the group consisting of polycarbonates, polyester carbonates, polyesters and polyam ides,
B) optionally at least one further thermoplastic polymer which is different from component A and is not completely miscible with component A,
C) 1 to 200 parts by weight, based on 100 parts by weight of component A, of a cross-linked or branched polymer,
wherein component C is formed in situ in an extruder or kneader during the melt compounding of component A and optional further components in the presence of
C.1 a first monomeric or oligomeric component comprising functional groups C.1.1 and
C.2 a second monomeric or oligomeric component comprising functional groups C.2.1 which are different from C.1.1,
by polyaddition or polycondensation in a reaction of the functional groups C.1.1 of component C.1 with the functional groups C.2.1 of component C.2,
where components C.1 and C.2 are
difunctional or higher-functionality compounds or are mixtures of one or more difunctional or higher-functionality compounds,
and wherein at least one of components C.1 and C.2 comprises higher-functionality compounds.

2. The polymer blend of claim 1, wherein the functional groups C.1.1 and C.2.1 are selected from the group of reaction pairings consisting of epoxy groups and carboxyl groups, epoxy and hydroxyl groups, hydroxyl and carboxyl groups, isocyanate and hydroxyl groups, amino and carboxyl groups, amino and epoxy groups, amino and isocyanate groups, and anhydride and amino groups.

3. The polymer blend of claim 1, wherein component C.1 and component C.2 are homogeneously miscible with the melt of component A in the quantitative ratios used under the conditions of the melt compounding of component A and optional further components.

4. The polymer blend of claim 1, comprising:
1 to 99 parts by weight of component A, based on a total of 100 parts by weight of components A and B,
99 to 1 parts by weight of component B, based on a total of 100 parts by weight of components A and B,
1 to 200 parts by weight, based on 100 parts by weight of component A, of a polymer of component C,
wherein component A and component B form separate phases in the polymer blend.

5. The polymer blend of claim 1, wherein component C forms a polymeric network which, in a temperature range below the decomposition temperatures of components A and C and also of optional component B, exchanges covalent bonds intramolecularly or intermolecularly in a dynamic manner.

6. The polymer blend of claim 1, comprising 10 to 50 parts by weight of component C, based on 100 parts by weight of component A.

7. The polymer blend of claim 1, wherein at least 40% by weight of the components of C.1 and C.2 used are converted to afford the polymer of component C.

8. The polymer blend of claim 1, further comprising as component D, 0.001 to 20 parts by weight, based on a total of 100 parts by weight of components A, B and C, of one or more polymer additives or processing auxiliaries.

9. The polymer blend of claim 8, wherein component D comprises a catalyst for the polycondensation or polyaddition reaction which leads to the formation of component C, the catalyst being selected from at least one representative of the group consisting of tin compounds, zinc compounds, zirconium compounds, samarium compounds, phosphonium salts and ammonium salts.

10. The polymer blend of claim 1, characterized in that component B is a polyolefin, a monophasic mixture of a plurality of miscible polyolefins or a monophasic mixture of a plurality of polymers comprising at least one polyolefin.

11. The polymer blend of claim 1, wherein component C is a crosslinked epoxy resin.

12. A process for producing a polymer blend of claim 1, comprising:
(i) in a first process step at least one of the components C.1 and C.2 is physically premixed with component A, and
(ii) in a second process step the premixture(s) produced in step (i) are melt compounded with addition of the remaining components and the polymer of component C is formed in the process by polyaddition or polycondensation and the final blend morphology is formed.

13. The process of claim 12, wherein in process step (i) first the components C.1 and C.2 and optionally further components are physically premixed together or separately with component A and in process step (ii), as component D, a catalyst for the polyaddition or polycondensation reaction of C.1 with C.2 is additionally added.

14. (canceled)

15. A shaped body produced from a polymer blend of claim 1.
